(19) United States
(12) Patent Application Publication
(10) Pub. No.: US 2009/0146328 A1
(43) Pub. Date: Jun. 11, 2009

(54) Method for Providing Lens Blanks

(76) Inventors: Ronald J. Koch, Webster, NY (US); Jay F. Kunzler, Canandaigua, NY (US); James A. Bonafini, JR., Pittsford, NY (US)

Correspondence Address: Bausch & Lomb Incorporated, One Bausch & Lomb Place, Rochester, NY, 14604-2701, US

(21) Appl. No.: 12/259,342

(22) Filed: Oct. 28, 2008

Related U.S. Application Data
(60) Provisional application No. 61/012,858, filed on Dec. 11, 2007.

(51) Int. Cl. B29D 11/00

(52) U.S. Cl. 264/1.32

(57) ABSTRACT

A method provides a machineable silicon-containing lens blank by removal of diluent from the lens blank. The method involves casting a lens blank in a mold, wherein the lens blank is made of a polymerization product of a monomeric mixture comprising a silicone-containing monomer and an organic diluent; removing the lens blank from the mold; and removing organic diluent from the lens blank.

### BACKGROUND OF THE INVENTION

This application claims the benefit of provisional patent application No. 61/012,858 filed Dec. 11, 2007, which is incorporated by reference herein.

The present invention relates to an improved method for making silicon-containing lens blanks that are machineable in a downstream operation. The invention is especially useful for lens blanks for machining contact lenses or intraocular lenses therefrom, particularly silicone hydrogel contract lenses or intraocular lenses.

The vast majority of soft contact lenses sold today are made by a static cast molding process. In static cast molding processes, a monomeric mixture is charged to a mold assembly comprising a first mold section including a surface for forming a desired anterior lens surface, and a second mold section including a surface for forming a desired posterior lens surface. This monomeric mixture is cured in the mold assembly to form a lens. Optionally, minor machining operations, such as cutting a desired edge profile, buffing the lens edge, or polishing the lens edge or surface, may be performed while the lens is retained in one of the mold sections, or after the lens has been removed from the mold assembly. Static cast molding offers an efficient and cost effective process for manufacturing large volumes of lenses, and thus, as mentioned, most soft contact lenses are currently made by such a process, instead of lathe cutting of contact lenses from a blank of lens material.

However, it may still be desired to machine a lens from a lens blank. As a first example, it may be desired to manufacture a custom contact lens (i.e., a contact lens having optical and/or fitting properties customized to an individual prescription) from a lens blank. As a second example, it may be desired to make lens blanks that are machined into individual lenses at a separate facility.

U.S. Pat. No. 5,260,000 (Nandu et al.) describes a process for preparing silicone hydrogel contact lenses by processes including static cast molding, spincasting, and variants thereof, where machining operations are employed to produce a lens having a desired final shape. The contact lenses are made of the polymerization product of a monomeric mixture comprising a silicone-containing monomer, a hydrophilic monomer and an organic diluent, where organic diluent is removed from the cast lens-shaped article prior to the machining operations.

The method of this invention provides silicon-containing lens blanks that are machineable in downstream operations, and that are cast from a monomeric mixture including a silicon-containing monomer and an organic diluent. Such blanks may have a cylindrical shape (in which case the blanks are frequently referred to as “buttons” in this art), and will typically have a thickness of at least 4 mm. (In contrast, contact lenses machined from the blanks, or contact lenses produced by a static cast molding method, may have a center thickness of less than 0.1 mm.) In some cases, it was found that removal of organic diluent from such larger lens blanks may tend to stress the polymeric material. Additionally, in some cases, it was found that the lens blanks were difficult to remove from the molds in which they were cast. This invention overcomes such problems, and provides methods for removing the organic diluent adequately and without deleteriously affecting the lens blank.

### SUMMARY OF THE INVENTION

This invention provides a method of providing a machineable silicon-containing lens blank, comprising, sequentially: casting a lens blank in a mold, wherein the lens blank is made of a polymerization product of a monomeric mixture comprising a silicone-containing monomer and an organic diluent; removing the lens blank from the mold; and removing organic diluent from the lens blank.

The lens blank is preferably made of a silicone hydrogel copolymer. The lens blank is preferably cylindrical in shape, preferably having a thickness of at least 4 mm, or even at least 5 mm.

According to certain embodiments, the method comprises, sequentially: casting the lens blank in the mold; removing the lens blank from the mold; replacing the organic diluent in the lens blank with water; and drying the lens blank to remove water.

According to other embodiments, the method comprises, sequentially: casting the lens blank in the mold; removing the lens blank from the mold; replacing the organic diluent in the lens blank with an organic solvent, and replace the organic solvent with water; and drying the lens blank to remove water.

According to additional embodiments, the method comprises, sequentially: casting the lens blank in the mold; partially removing organic diluent from the lens blank, and releasing the lens blank from the mold; and removing additional organic diluent from the lens blank removed from the mold.

### DETAILED DESCRIPTION OF VARIOUS PREFERRED EMBODIMENTS

The present invention provides a method of providing machineable silicon-containing lens blanks, where the lens blank is cast in a mold and is made of the polymerization product of a monomeric mixture comprising a silicone-containing monomer and an organic diluent. In the following description, the process is discussed with particular reference to lens blanks made of a silicone hydrogel copolymer, a preferred embodiment of this invention, but the invention may be employed for other silicon-containing polymeric materials that include an organic diluent for casting. In the following description, the process is discussed with particular reference to lens blanks for subsequent machining into contact lenses, but the lens blanks may be machined into other lens shaped articles, such as intraocular lenses.

Hydrogels comprise a hydrated, crosslinked polymeric system containing water in an equilibrium state. Accordingly, hydrogels are copolymers prepared from hydrophilic monomers. In the case of silicone hydrogels, the hydrogel copolymers are generally prepared by polymerizing a mixture containing at least one silicone-containing monomer and at least one hydrophilic monomer. Either the silicone-containing monomer or the hydrophilic monomer may function as a crosslinking agent (a crosslinking agent being defined as a monomer having multiple polymerizable functionalities), or alternately, a separate crosslinking agent may be employed in the initial monomer mixture from which the hydrogel copolymer is formed. (As used herein, the term “monomer” or “monomeric” and like terms denote relatively low molecular weight compounds that are polymerizable by free radical polymerization, as well as higher molecular weight compounds also referred to as “prepolymers”, “macromonomers”, and related terms.) Silicone hydrogels typically have water content between about 10 to about 80 weight percent.

This invention relates to silicon-containing polymeric systems that employ an organic diluent is included in the initial monomeric mixture. As used herein, the term “organic diluent” encompasses organic compounds which minimize incompatibility of the components in the initial monomeric mixture and are substantially nonreactive with the components in the initial mixture. Representative organic diluents include: monohydric alcohols, with C₆-C₁₀ straight-chained aliphatic monohydric alcohols, such as n-hexanol and n-nonanol, being especially preferred; diols, such as ethylene glycol; polyols, such as glycerin; ethers, such as diethylene glycol monoethyl ether; ketones, such as methyl ethyl ketone; esters, such as methyl enanthate; and hydrocarbons, such as toluene. Preferably, the organic diluent is sufficiently volatile to facilitate its removal from a cured article by evaporation at or near ambient pressure. Other suitable organic diluents would be apparent to a person of ordinary skill in the art. The organic diluent is included in an amount effective to provide the desired effect. Generally, the diluent is included at 5 to 60% by weight of the monomeric mixture, especially at 10 to 50% by weight.

Examples of useful hydrophilic monomers include: amides such as N,N-dimethylacrylamide and N,N-dimethylmethacrylamide; cyclic lactams such as N-vinyl-2-pyrrolidone; (meth)acrylated alcohols, such as 2-hydroxyethyl methacrylate, 2-hydroxyethyl acrylate and glyceryl methacrylate; (meth)acrylated poly(ethylene glycol)s; (meth)acrylic acids such as methacrylic acid and acrylic acid; and N-vinyloxycarbonylalanine; and azlactone-containing monomers, such as 2-isopropenyl-4,4-dimethyl-2-oxazolin-5-one and 2-vinyl-4,4-dimethyl-2-oxazolin-5-one. (As used herein, the term “(meth)” denotes an optional methyl substituent. Thus, terms such as “(meth)acrylate” denotes either methacrylate or acrylate, and “(meth)acrylic acid” denotes either methacrylic acid or acrylic acid.) Still further examples are the hydrophilic vinyl carbonate or vinyl carbamate monomers disclosed in U.S. Pat. No. 5,070,215, and the hydrophilic oxazolone monomers disclosed in U.S. Pat. No. 4,910,277, the disclosures of which are incorporated herein by reference. Other suitable hydrophilic monomers will be apparent to one skilled in the art.

The aforementioned (meth)acrylic acids and N-vinyloxycarbonylalanines are representative of suitable acid containing monomers employed in the monomer mixtures of this invention. These acid containing monomers may be the sole hydrophilic monomer in the monomer mixture, or they may be employed along with another hydrophilic monomer. Specific examples of acid-containing monomers include: acrylic acid; methacrylic acid; malefic acid; itaconic acid; vinyl carbamate-containing acids; and vinyl carbonate-containing acids.

Applicable silicone-containing monomeric materials for use in the formation of silicone hydrogels are well known in the art and numerous examples are provided in U.S. Pat. Nos. 4,136,250; 4,153,641; 4,740,533; 5,034,461; 5,070,215; 5,260,000; 5,310,779; and 5,358,995.

Examples of applicable silicone-containing monomers include bulky polysiloxanylalkyl(meth)acrylic monomers. An example of such monofunctional, bulky polysiloxanylalkyl(meth)acrylic monomers are represented by the following Formula I:

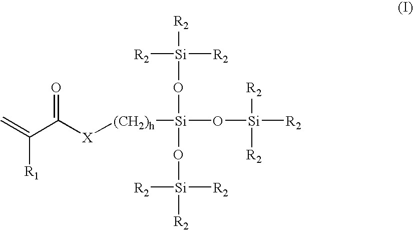

wherein:

X denotes —O— or —NR—;

each R₁ independently denotes hydrogen or methyl;

each R₂ independently denotes a lower alkyl radical, phenyl radical or a group represented by

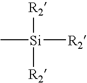

wherein each R₂′ independently denotes a lower alkyl or phenyl radical; and h is 1 to 10. One preferred bulky monomer is 3-methacryloxypropyl tris(trimethylsiloxy)silane or tris(trimethylsiloxy)silylpropyl methacrylate, sometimes referred to as TRIS.

Another class of representative silicone-containing monomers includes silicone-containing vinyl carbonate or vinyl carbamate monomers such as: 1,3-bis[4-vinyloxycarbonyloxy)but-1-yl]tetramethyldisiloxane; 1,3-bis[4-vinyloxycarbonyloxy)but-1-yl]polydimethylsiloxane; 3-(trimethylsilyl)propyl vinyl carbonate; 3-(vinyloxycarbonylthio)propyl[tris(trimethylsiloxy)silane]; 3-[tris(trimethylsiloxy)silyl]propyl vinyl carbamate; 3-[tris(trimethylsiloxy)silyl]propyl allyl carbamate; 3-[tris(trimethylsiloxy)silyl]propyl vinyl carbonate; t-butyldimethylsiloxyethyl vinyl carbonate; trimethylsilylethyl vinyl carbonate; and trimethylsilylmethyl vinyl carbonate.

An example of silicone-containing vinyl carbonate or vinyl carbamate monomers are represented by Formula II:

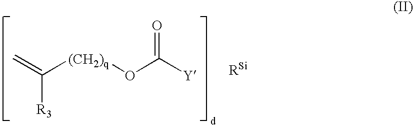

wherein:

Y′ denotes —O—, —S— or —NH—;

R^{Si} denotes a silicone-containing organic radical;

R₃ denotes hydrogen or methyl;

d is 1, 2, 3 or 4; and q is 0 or 1.

Suitable silicone-containing organic radicals R^{Si} include the following:

—(CH₂)_{n′}Si[(CH₂)_{m′}CH₃]₃;

—(CH₂)_{n′}Si[OSi(CH₂)_{m′}CH₃]₃;

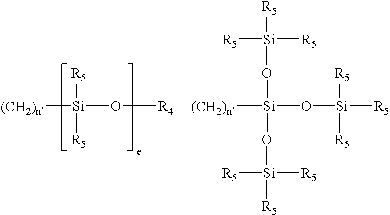

and

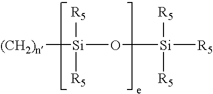

wherein:

R₄ denotes

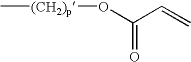

wherein p′ is 1 to 6;

R₅ denotes an alkyl radical or a fluoroalkyl radical having 1 to 6 carbon atoms;

e is 1 to 200; n′ is 1, 2, 3 or 4; and m′ is 0, 1, 2, 3, 4 or 5.

An example of a particular species within Formula II is represented by Formula III:

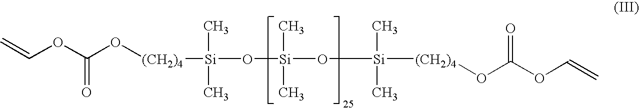

Another class of silicone-containing monomers includes polyurethane-polysiloxane macromonomers (also sometimes referred to as prepolymers), which may have hard-soft-hard blocks like traditional urethane elastomers. Examples of silicone urethane monomers are represented by Formulae IV and V:

E(*D*A*D*G)ₐ*D*A*D*E′; or (IV)

E(*D*G*D*A)ₐ*D*G*D*E′; (V)

wherein:

D denotes an alkyl diradical, an alkyl cycloalkyl diradical, a cycloalkyl diradical, an aryl diradical or an alkylaryl diradical having 6 to 30 carbon atoms;

G denotes an alkyl diradical, a cycloalkyl diradical, an alkyl cycloalkyl diradical, an aryl diradical or an alkylaryl diradical having 1 to 40 carbon atoms and which may contain ether, thio or amine linkages in the main chain;

* denotes a urethane or ureido linkage;

a is at least 1;

A denotes a divalent polymeric radical of Formula VI:

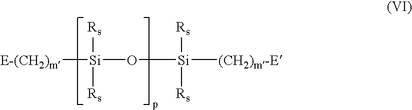

wherein:
each Rₛ independently denotes an alkyl or fluoro-substituted alkyl group having 1 to 10 carbon atoms which may contain ether linkages between carbon atoms;
m′ is at least 1; and
p is a number which provides a moiety weight of 400 to 10,000;
each of E and E′ independently denotes a polymerizable unsaturated organic radical represented by Formula VII:

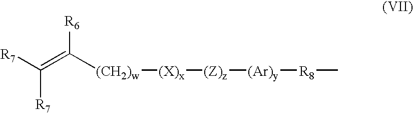

wherein:

R₆ is hydrogen or methyl;

R₇ is hydrogen, an alkyl radical having 1 to 6 carbon atoms, or a —CO—Y—R₉ radical wherein Y is —O—, —S— or —NH—;

R₈ is a divalent alkylene radical having 1 to 10 carbon atoms;

R₉ is a alkyl radical having 1 to 12 carbon atoms;

X denotes —CO— or —OCO—;

Z denotes —O— or —NH—;

Ar denotes an aromatic radical having 6 to 30 carbon atoms;

w is 0 to 6; x is 0 or 1; y is 0 or 1; and z is 0 or 1.

A more specific example of a silicone-containing urethane monomer is represented by Formula (VIII):

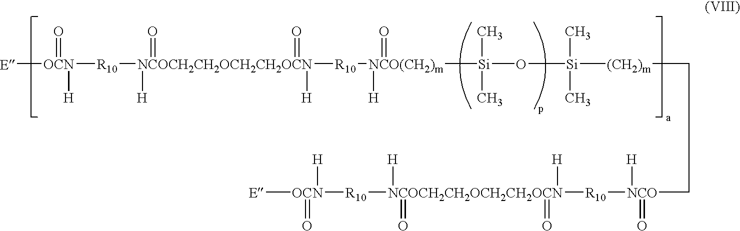

wherein m is at least 1 and is preferably 3 or 4, a is at least 1 and preferably is 1, p is a number which provides a moiety weight of 400 to 10,000 and is preferably at least 30, R₁₀ is a diradical of a diisocyanate after removal of the isocyanate group, such as the diradical of isophorone diisocyanate, and each E″ is a group represented by:

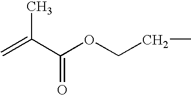

A preferred silicone hydrogel material comprises (based on the initial monomer mixture that is copolymerized to form the hydrogel copolymeric material) 5 to 50 percent, preferably 10 to 25, by weight of one or more silicone macromonomers, 5 to 75 percent, preferably 30 to 60 percent, by weight of one or more polysiloxanylalkyl(meth)acrylic monomers, and 10 to 50 percent, preferably 20 to 40 percent, by weight of a hydrophilic monomer. In general, the silicone macromonomer is a poly(organosiloxane) capped with an unsaturated group at two or more ends of the molecule. In addition to the end groups in the above structural formulas, U.S. Pat. No. 4,153,641 to Deichert et al. discloses additional unsaturated groups, including acryloxy or methacryloxy. Fumarate-containing materials such as those taught in U.S. Pat. Nos. 5,512,205; 5,449,729; and 5,310,779 to Lai are also useful substrates in accordance with the invention. Preferably, the silane macromonomer is a silicone-containing vinyl carbonate or vinyl carbamate or a polyurethane-polysiloxane having one or more hard-soft-hard blocks and end-capped with a hydrophilic monomer.

Specific examples of contact lens materials for which the present invention is useful are taught in U.S. Pat. No. 6,891,010 (Kunzler et al.); U.S. Pat. No. 5,908,906 (Kunzler et al.); U.S. Pat. No. 5,714,557 (Kunzler et al.); U.S. Pat. No. 5,710,302 (Kunzler et al.); U.S. Pat. No. 5,708,094 (Lai et al.); U.S. Pat. No. 5,616,757 (Bambury et al.); U.S. Pat. No. 5,610,252 (Bambury et al.); U.S. Pat. No. 5,512,205 (Lai); U.S. Pat. No. 5,449,729 (Lai); U.S. Pat. No. 5,387,662 (Kunzler et al.); U.S. Pat. No. 5,310,779 (Lai); and U.S. Pat. No. 5,260,000 (Nandu et al.), the disclosures of which are incorporated herein by reference. One specific example is balafilcon A.

The monomer mixture are charged to a mold, and then subjected to heat and/or light radiation, such as UV radiation, to effect curing, or free radical polymerization, of the monomer mixture in the mold. The mold cavity, in which the monomer mixture is charged and polymerized, is shaped to provide a desired lens blank. Preferably, the lens blank has a thickness of at least 4 mm, more preferably at least 5 mm, and is cylindrically shaped. It will be appreciated that the lens blanks are much larger in volume and mass than contact lenses.

Then, the lens blank is removed from the mold, and organic diluent is removed from the lens blank. Removal of organic diluent is required so that the lens blanks are machineable by lathing, i.e., so that the lens blanks are not too rubbery or too tacky.

According to one specific embodiment, organic diluent is removed from the lens blank by replacing the organic diluent with water, followed by drying the lens blank to remove water. This may be done by soaking the lens blank in water for sufficient time to replace the desired amount of diluent with water.

Alternately, organic diluent may be removed by, first, replacing organic diluent in the lens blank with an organic solvent, for example, by soaking the sufficient time to replace the desired amount of diluent with the organic solvent, and then replacing the organic solvent with water. The organic solvent is an organic compound different from, and having a higher vapor pressure than, the organic diluent. Representative organic solvents include isopropanol and ethanol.

In these embodiments, where the organic diluent is replaced directly with water or initially with the organic solvent, it is preferred that the water or solvent contact all surfaces of the lens blank. Since the lens blank is relatively thick and relatively large in volume (as compared to a contact lens), it was found that replacement of the diluent is much more effective if the water or solvent completely surrounds the lens blank. This may be accomplished by supporting the lens blank on a porous substrate while in contact with the water or the organic diluent. The porous substrate may comprise a perforated tray, a porous membrane sheet, or the like.

In the case where an organic solvent, such as isopropanol, is used to replace the diluent, this solvent may be replaced with water by soaking the lens blank in a series of mixtures of the solvent and water, with successive higher amounts of water than solvent. For example, the lens blank may be first soaked in pure isopropanol, then soaked in a mixture of isopropanol and water at a weight ratio of 85:15, then soaked in a mixture of isopropanol and water at a ratio of 50:50, and finally soaked in water alone, with additional intermediate soaking steps at intermediate ratios, if desired.

According to another specific embodiment, especially useful in cases where the lens blank is difficult to remove from the mold, it may be desired to partially remove organic diluent from the lens blank, in order to facilitate release of the lens blank from the mold. Subsequently, after removing the lens blank from the mold, additional organic diluent is removed from the lens blank.

As an example, the lens blank, while retained in a mold part, may be placed in a heated oven, preferably under vacuum. As some of the diluent evaporates from the lens blank, the lens blank will shrink in volume and shrink away from the mold part. Then, the lens may be removed from the mold part and returned to the oven until a desired amount of diluent is removed. For example, the oven may be heated to at least 50° C., more preferably at least 60° C., and even at least 80° C., at a pressure of about 25 mm Hg.

It is noted that for the various embodiments, it is not necessary that all diluent be removed from the lens blank. Rather, a sufficient amount of diluent is ultimately removed from the lens blank so that the lens blank is machineable. If some diluent remains in the lens blank, the lens machined from the lens blank may be extracted with an organic solvent and/or water to remove any remaining diluent.

The methods of this invention provide a lens blank that now can be machined into a lens using conventional lathe equipment. The lens blank may be immediately lathed, or it may be stored for later lathing or packaged and shipped to an alternate location.

Having thus described the preferred embodiment of the invention, those skilled in the art will appreciate that various modifications, additions, and changes may be made thereto without departing from the spirit and scope of the invention, as set forth in the following claims.

We claim:

1. A method of providing a machineable silicon-containing lens blank, comprising, sequentially:
casting a lens blank in a mold, wherein the lens blank is made of a polymerization product of a monomeric mixture comprising a silicone-containing monomer and an organic diluent;
removing the lens blank from the mold; and
removing organic diluent from the lens blank.

2. The method of claim 1, wherein the lens blank is made of a silicone hydrogel copolymer.

3. The method of claim 1, wherein the lens blank is cylindrical.

4. The method of claim 1, wherein the lens blank has a thickness of at least 4 mm.

5. The method of claim 1, wherein the lens blank has a thickness of at least 5 mm.

6. The method of claim 1, wherein the lens blank is placed in a heated oven during removal of organic diluent.

7. The method of claim 6, wherein the oven is under vacuum.

8. The method of claim 1, comprising, sequentially:
casting the lens blank in the mold;
removing the lens blank from the mold;
replacing the organic diluent in the lens blank with water; and
drying the lens blank to remove water.

9. The method of claim 8, wherein the lens blank is supported on a porous substrate while organic diluent is replaced with water.

10. The method of claim 1, comprising, sequentially:
casting the lens blank in the mold;
removing the lens blank from the mold;
replacing the organic diluent in the lens blank with an organic solvent, and replace the organic solvent with water; and
drying the lens blank to remove water.

11. The method of claim 10, wherein the lens blank is supported on a porous substrate while organic diluent is replaced with organic solvent.

12. The method of claim 11, wherein the porous substrate comprises a perforated tray.

13. The method of claim 11, wherein the porous substrate comprises a porous membrane.

14. The method of claim 11, wherein the lens blank is cylindrical and has a thickness of at least 4 mm.

15. The method of claim 1, comprising, sequentially:
casting the lens blank in the mold;
partially removing organic diluent from the lens blank, and releasing the lens blank from the mold; and
removing additional organic diluent from the lens blank removed from the mold.

16. The method of claim 15, wherein the lens blank is cylindrical and has a thickness of at least 4 mm.

17. The method of claim 15, wherein the lens blank is placed in a heated oven during removal of organic diluent.

18. The method of claim 17, wherein the oven is under vacuum.
